(19) United States
(12) Patent Application Publication
(10) Pub. No.: US 2017/0312958 A1
(43) Pub. Date: Nov. 2, 2017

(54) VEHICLE INTERIOR COMPONENT

(71) Applicant: Shanghai Yanfeng Jinqiao Automotive Trim Systems Co Ltd, Plymouth, MI (US)

(72) Inventors: Iris Wegner, Saarbruecken (DE); Martin Kuckertz, Neuss (DE)

(21) Appl. No.: 15/652,803

(22) Filed: Jul. 18, 2017

Related U.S. Application Data
(63) Continuation of application No. PCT/EP16/51604, filed on Jan. 26, 2016.

(51) Int. Cl. B29C 45/14; B60R 13/02; B29L 31/30; B29K 101/12

(52) U.S. Cl. CPC B29C 45/14688; B60R 13/0256; B29C 2045/14704; B29K 2101/12; B29C 2795/005; B60Y 2410/122; B29L 2031/3041

(57) ABSTRACT

A vehicle interior component is disclosed. The component for a vehicle interior may comprise a base comprising a surface and a depression in the surface and a first decorative layer coupled to the base and comprising a front surface and a rear surface. The first decorative layer may be at least partially contained in the depression of the surface of the base. The first decorative layer may be at least partially absorbed into the base. The vehicle interior component may comprise one or more of the inventive concepts and features shown and described in the FIGURES and Appendices and specification.

### CROSS REFERENCE TO RELATED APPLICATIONS

The present application is a continuation of PCT/EP16/051604 titled “VEHICLE INTERIOR COMPONENT” filed Jan. 26, 2016.

The present application claims priority from and the benefit of and incorporates by reference in entirety of PCT/EP16/051604 titled “VEHICLE INTERIOR COMPONENT” filed Jan. 26, 2016.

### FIELD

The present invention relates to a vehicle interior component. The present invention generally relates to components for a vehicle interior, more particularly, to interior trim parts, for example, vehicle trim panels, having regions of different esthetic characteristics, such as color or material. The present invention also relates to a process for manufacturing such vehicle interior components.

### BACKGROUND

It is well-known in motor vehicles to provide a trim component, in particular a trim panel, for covering the vehicle interior structure, such as the instrument panel or the door. Such interior trim parts are commonly found on automotive vehicle headliners, door panels, instrument panels, center consoles, as well as various other interior trim components in a vehicle such as an automobile. Typical vehicle interior trim components contain a protective outer skin layer, such as a polyvinylchloride (PVD), and a rigid structural substrate on the back. Quite often, there is also a soft urethane foam interstitial layer disposed between the protective outer skin layer and the rigid structural substrate.

A conventional vehicle interior trim part is generally manufactured in a multiple-step process, in which the structural substrate is molded in a first die. The molded structural substrate is then typically adhesively attached to a foam material having an outer trim layer, such as a PVC skin.

It is often desirable to provide such a vehicle trim component, in particular vehicle trim panel, having regions of different esthetic characteristics. For example, it may be desirable to provide a trim panel or instrument panel having regions of different color.

Accordingly, it would be advantageous to provide a vehicle interior component such as a door panel or instrument panel in which different regions of the vehicle interior component have different colors or other esthetic characteristics.

There is also a need for ornamented or decorated interior trim parts having a colored and abrasion-resistant coating. Hence, it is desired to implement, in a most cost-efficient way, possible unique decorations of interior trim parts in a vehicle interior in order to generate different customer-specific styles.

In this context, it is to be mentioned that the so-called In-Mold-Decoration (IMD) process is already known for decorating plastic surfaces. This conventional IMD process is a specific back-molded foil process. In more detail, with the IMD-process, a printed transfer-foil is inserted into an injection mold and then back-injected with a polymer meld. During back-molding, the color of the transfer-foil is at least partly transferred to the casting and is released from the transfer-foil when the injection mold is opened. Thereafter, the coated part may be removed from the injection mold.

With this conventional process, the color originally coated on the transfer-foil is transferred to the casting. Accordingly, for a next process, the transfer-foil needs to be replaced.

One drawback of this kind of decoration, however, is that high quality and, in particular, abrasion-resistant transfer-foils need to be used, which have to match exactly the 2D-geometry of a 3D-body to be decorated. Since the transfer-foil together with the transferable picture has to be replaced at the beginning of each every process, the IMD-process is a relatively cost intensive process for producing refinement. Furthermore, the high consumption of transfer-foils is of disadvantage with respect to environmental compatibility.

Hence, it would also be advantageous to provide a vehicle interior component which may be formed by a more environmentally compatible and cost-effective way, wherein at the same time the vehicle interior component may be refined and, in particular, individually decorated.

Moreover, it would also be advantageous to provide an interior trim component for vehicles, in which—in addition to the primary function of the interior part, namely to cover body elements—more functionalities may be integrated in a particularly simple, inexpensive and environmentally friendly way.

### SUMMARY

The present invention relates to a component for a vehicle interior. The component may comprise a base comprising a surface and a depression in the surface and a first decorative layer coupled to the base and comprising a front surface and a rear surface. The first decorative layer may be at least partially contained in the depression of the surface of the base. The first decorative layer may be at least partially absorbed into the base. The first decorative layer may be at least partially absorbed into the base as the base and the decorative layer are molded into a shape. The component may also comprise a protective layer wherein the protective layer may be configured to cover the surface of the base and the first decorative layer. The first decorative layer may be fully contained in the depression of the base. The front surface of the first decorative layer may be substantially adjacent to the surface of the base. A depth of the depression may be substantially greater than a thickness of the first decorative layer. The component may also comprise a second decorative layer comprising a first front surface, a second front surface and a rear surface; the second front surface of the second decorative layer may be adjacent the rear surface of the first decorative layer. The first front surface of the second decorative layer may be substantially adjacent to the front surface of the first decorative layer. The first front surface of the second decorative layer may be substantially adjacent to the surface of the base. The first decorative layer may comprise ink.

The present invention also relates to a method of manufacturing a vehicle component for a vehicle interior. The method may comprise providing a mold comprising a mold bottom and a mold top, heating the mold bottom, providing a decorative layer in the mold, closing the mold, injecting resin (a) between the decorative layer and the mold top and (b) between the mold bottom and the mold top to form a base and to provide the vehicle component and removing the vehicle component from the mold. The method may comprise the step of partially absorbing at least a portion of the decorative layer into the base; the method may comprise the step of applying a protective layer to the mold bottom. Providing the decorative layer in the mold may comprise applying the decorative layer to the protective layer. The decorative layer may comprise ink.

The present invention further relates to a vehicle trim component prepared by a process. The process may comprise providing a mold comprising a mold bottom and a mold top; heating the mold bottom; providing a decorative layer in the mold; closing the mold; injecting resin (a) between the decorative layer and the mold top and (b) between the mold bottom and the mold top to form a base and to provide the component; and removing the component from the mold. The process may comprise the step of partially absorbing at least a portion of the decorative layer into the base. The process may comprise the step of applying a protective layer to the mold bottom. Providing the decorative layer in the mold comprises applying the decorative layer to the protective layer. The decorative layer may comprise ink.

### FIGURES

FIG. 1A is a schematic perspective view of a vehicle according to an exemplary embodiment.

FIG. 1B is a schematic perspective view of a vehicle interior according to an exemplary embodiment.

FIG. 1C is a schematic perspective view of the vehicle interior according to an exemplary embodiment.

FIG. 2A is a schematic perspective sectional cut view of the vehicle interior component according to an exemplary embodiment.

FIG. 2B is a schematic sectional view through the vehicle interior component according to an exemplary embodiment.

FIGS. 3A through 3F are schematic diagrams of a process for manufacturing a vehicle interior component according to an exemplary embodiment.

FIGS. 4A through 4G are schematic diagrams of a process for manufacturing a vehicle interior component according to an exemplary embodiment.

FIGS. 5A through 5G are schematic diagrams of a process for manufacturing a vehicle interior component according to an exemplary embodiment.

FIGS. 6A through 6F are schematic diagrams of a process for manufacturing a vehicle interior component according to an exemplary embodiment.

FIGS. 7A through 7D are schematic exemplary embodiments of the component with base (e.g. resin, plastic, injection molded material, etc.) and decorative layer (e.g. ink, deposit, etc.) in partial cross-section according to an exemplary embodiment.

FIGS. 8A and 8B show schematically the effect of operating conditions of the formation of a component with base and layer according to an exemplary embodiment.

### DESCRIPTION

The depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Before any exemplary embodiments of the invention are described in detail, it is further to be understood that the invention is not limited in its application to the details of construction and the arrangement of components set forth in the following description or illustrated in the following drawings. The invention is capable of other embodiments and of being practiced or of being carried out in various ways. It is also to be understood that the phraseology and terminology employed herein is for the purpose of description and should not be regarded as limiting. For example, the terms “substrate”, “base”, “ink”, and “decorative layer” are intended to be broad terms and not terms of limitation. These components may be used with any of a variety of products or arrangements and are not intended to be limited to use with automotive applications.

Moreover, before beginning the detailed description of the exemplary embodiments, several general comments are warranted about the applicability and the scope of the present invention.

According to exemplary embodiments, a vehicle interior component, in particular, a trim component for a vehicle (e.g., a door panel, an instrument panel IP, a trim element of a dash board or a component assembly) is provided that is adapted for use in any variety of application of a vehicle V (e.g., automobile, plane, train).

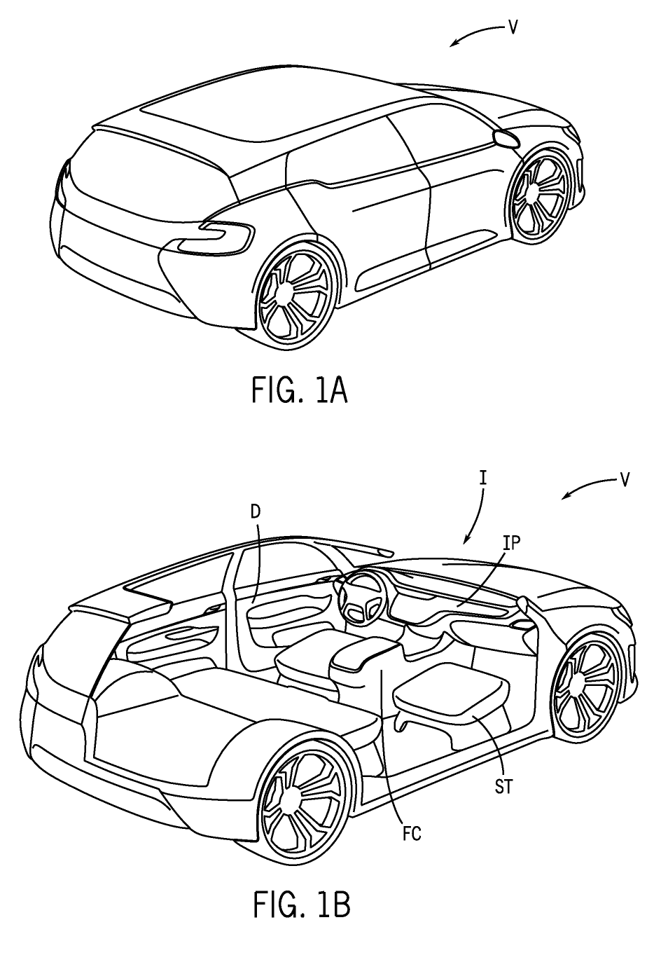

FIG. 1A is a perspective view of an exemplary vehicle V that may include molded trim parts, trim components and/or interior components.

As illustrated in FIG. 1B, the vehicle V includes an interior I having a vehicle seat assembly ST, a floor console FC, and an instrument panel IP. As discussed in detail below, certain components of the seat assembly ST, the door D of the vehicle V, the floor console FC, a center console, the instrument panel IP, and/or other areas within the interior I may include thermoplastic parts, in particular foamed thermoplastic parts. These interior components or trim parts have a class A surface. As used herein, the term “class A surface” means any surface of a vehicle interior trim part or component, that has styling intent, that is either able to be seen, touched or both.

In general, the vehicle interior parts or trim components described in this disclosure may be molded articles having one or more localized or displayed areas, or portions of softness or cushioning. In some embodiments, the molded article may be configured as a trim part or trim panel for use in a vehicle (e.g., automobile, such as car, truck, bus, and the like; airplane; etc.).

The vehicle trim component may be provided with one or more localized discrete areas or portions of softness or cushioning, which enables the trim component to selectively include areas of softness in areas that are likely to be interfaced by a passenger or other individuals, without the need of providing cushioning to the entire trim part. In this manner, the areas of cushioning may be optimized based on the typical passenger experience.

Furthermore, apart from cushioning of the trim component, the optical characteristics of the trim component, such as color, form, etc., as well as haptic characteristics, may be optimized by choosing different materials such as leather of PVC.

The vehicle interior component described in this disclosure may be employed in a variety of applications, and is generally applicable with any application. As mentioned above, in some embodiments of the present disclosure, the vehicle interior component may be an instrument panel IP, a door panel or any other vehicle interior parts for use in a vehicle V.

While the disclosed embodiments may be described as a vehicle trim component, such as an instrument panel IP, the features of the disclosed embodiments are equally applicable with other applications, such as other panels, molded articles and components.

The vehicle interior components described herein are molded thermoplastic parts and, in particular foamed thermoplastic parts.

FIG. 1C shows a perspective view of the interior I of the vehicle V of FIG. 1A in greater detail. In more detail, FIG. 1C is a perspective view of an instrument panel IP or dashboard employed in a vehicle, for example, the vehicle V illustrated in FIG. 1A. The instrument panel IP or dashboard illustrated in FIG. 1C has various vehicle display options and trim components according to exemplary embodiments of the present disclosure. As illustrated in FIG. 1C, the interior trim components of the instrument panel IP or dashboard may be provided with at least one decorative layer, for example, in the form of an elongated stripe having a color, form and/or haptic characteristics which is different with regard to the color, form and/or haptic characteristics of the material adjacent to the decorative layer.

The interior I is shown in FIG. 1C to include a door D and an instrument panel IP. The door D and instrument panel IP each may comprise an outer trim component or panel that is formed by a coverstock or cover assembly coupled to a base (e.g., a rigid base, panel, etc.) for structural support. The trim panel may include a decorative layer coupled to the base to provide a desired appearance, ornamental appearance and/or a functional component.

For the purpose of this disclosure, a vehicle interior component coupled to or forming at least partly the instrument panel IP will be further described but should be understood by a person having ordinary skill in the art reading this disclosure that the vehicle interior component could also be coupled to the door D of the vehicle V, or other surfaces within the vehicle V, or used in other applications where a panel with multiple different cover materials is desired (e.g., in applications not involving a vehicle such as vehicle V.

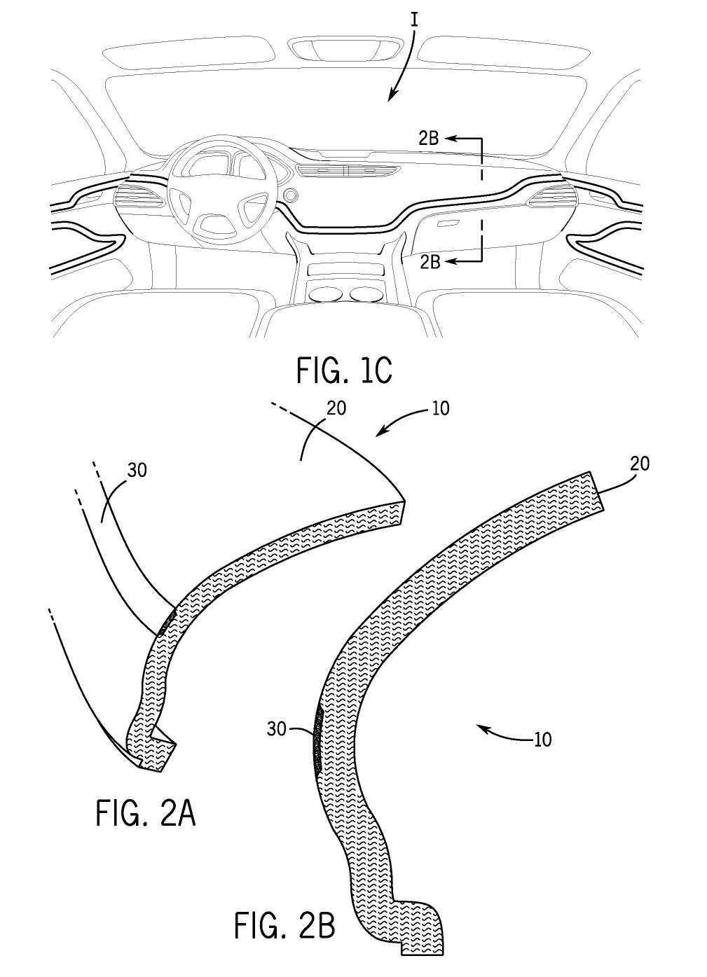

FIG. 2A is a detailed enlargement of a part of the instrument panel IP of FIG. 1C, wherein this part of the instrument panel IP may be regarded as being a vehicle interior component in accordance with one exemplary embodiment of the present disclosure. In FIG. 2A, the vehicle interior component of the instrument panel IP is shown in a perspective sectional cut view.

FIG. 2B is a sectional view of the vehicle interior component according to FIG. 2A, said sectional view being taken along the line 2B-2B in FIG. 1C.

Referring to FIG. 2A, the vehicle interior component 10 according to this exemplary embodiment comprises a base 20 having a surface, which is visible (e.g., to an occupant) when the vehicle interior component 10 is mounted in a vehicle interior I. In the surface of the base 20, a depression is formed. The interior component 10 according to the exemplary embodiment further comprises a first decorative layer 30 coupled to the base 20 and also comprising a front surface and a rear surface. As illustrated in particular in FIG. 2B, the first decorative layer 30 is at least partly contained in the depression of the surface of the base 20.

According to some embodiments of the present disclosure, the base 20 provides the substantial, if not the entire, structural support for the vehicle interior component 10 generally, and may provide structural support to various components that are attached to the vehicle interior component 10 (e.g., arm rest, speakers, handles, etc.)

With the first decorative layer 30, the base 20 further provides an ornamental or decorative appearance.

Surfaces of the vehicle interior component 10 that are visible (e.g., to an occupant), when the vehicle interior component 10 is mounted in a vehicle interior I, are generally referred to as the “A” surface or side. Portions of surfaces of the base 20 may provide an “A” surface. Other portions or surfaces of the base 20 may be obscured or covered by a cover stock, cover assembly, or other components.

According to some exemplary embodiments, the base 20 is a rigid structure and is formed by injection molding a resin, for example a polymer resin, in a process that uses heat and pressure to inject a molten resin into a cavity formed in a mold tool.

According to various exemplary embodiments disclosed herein, the base 20 may be made from a variety from suitable materials. For example, injection molded polypropylene is one material for making the base 20, but other materials may be used, including other thermoplastic resins, such as polyethylene, acrylonitrile butadiene styrene (ABS), polyurethane nylon, any of a variety of homo polymer plastics, copolymer plastics, plastics with special additives, filled plastics, etc. Also, other molding operations may be used to form the base 20, such as injection compression molding, etc.

In some embodiments of the inventive component 10 disclosed herein, the “A” surface of the vehicle interior component 10 may provide an ornamental or decorative appearance to the vehicle interior component 10 using a first decorative layer 30 coupled to the base 20. The first decorative layer may also provide a functional feature to the vehicle interior component 10, a depressed or raised portion of the vehicle interior component 10, a different surface compared to the surface of the base 20, or the like.

As schematically indicated in FIG. 2B, a depth of the depression formed in the surface of the base 20 is relatively low compared with the total thickness of the base 20. According to some exemplary embodiments, a depth of the depression is less than approximately 50 mm as measured in relation to a plane in which the surface of the base 20 is situated. The base 20 may have a total thickness of approximately 2 mm to approximately 5 mm.

In accordance with some embodiments disclosed herein, the base 20 may be provided with a reinforcement layer arranged at least in the area of the depression on a surface of the base 20 opposite to the depression in which the first decorative layer 20 is at least partly contained in order to provide structural support. The reinforcement layer may be made of the same material as the base 20 and/or may be integrally formed with the base 20.

Although not illustrated in FIG. 2B, the exemplary embodiment of the inventive vehicle interior component 10 may further comprise a mixing area located at least partly between the base 20 and the first decorative layer 30. Such a mixing area may be characterized in that it comprises material of the base 20 on the one hand, and material of the first decorative layer 30 on the other hand.

As will be described in more detail below, the mixing area may be formed by absorbing at least some of the material of the first decorative layer 30 in the material of the base 20.

According to some embodiments disclosed herein, the first decorative layer 30 may comprise a printable material, in particular ink. For example, the first decorative layer 20 may comprise a thermoformable material. Also, the first decorative layer 30 may comprise pigments.

Although not illustrated in FIGS. 2A and 2B, the vehicle interior component 10 may further comprise a protective layer. The term “protective layer” as used herein refers to a layer, which is configured to cover the “A”-surface of the base 20 and the “A”-surface of the first decorative layer 30.

The protective layer may comprise a material different from the material of the base 20 and/or different from the material of the first decorative layer 30. In some embodiments, the protective layer may comprise a printable and/or sprayable material, e.g., a polymer, in particular a polymer of an alkyl ester of acrylic or met acrylic acid. The protective layer may also comprise ethylene.

According to some embodiments of the inventive vehicle interior component 10, the component 10 may comprise at least one further (second) decorative layer not illustrated in FIGS. 2A and 2B.

The further (second) decorative layer may comprise a first front surface, a second front surface, and a rear surface, wherein the second front surface of the second decorative layer may be adjacent the rear surface of the first decorative layer. On the other hand, the second front surface of the second decorative layer may be adjacent the front surface of the base, i.e. the surface of the base, in which the depression is formed.

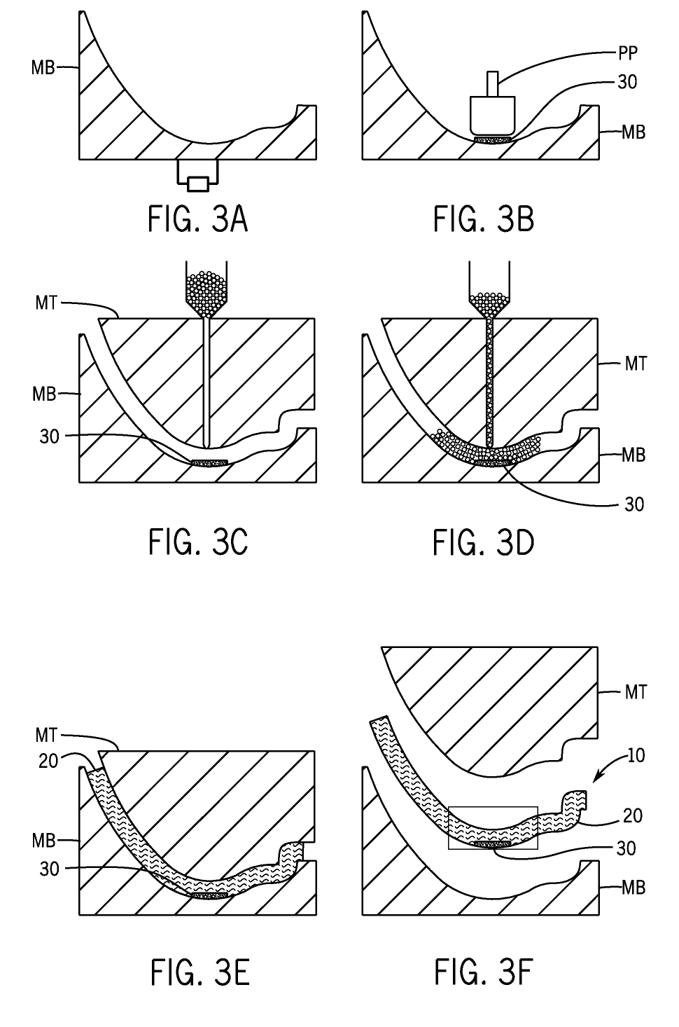

Referring now to FIGS. 3A to 3F, a process for making a vehicle interior component 10 according to an exemplary embodiment will be described in greater detail.

Referring to FIGS. 3A to 3C, in a first process step, a mold comprising a mold bottom MB and a mold top MT is provided.

Preferably, the mold bottom MB may be heated to a temperature of between approximately 50 degrees Celsius to approximately 120 degrees Celsius. For this reason, at least the mold bottom MB is provided with corresponding heating means, as schematically illustrated in FIG. 3A.

For the purpose of the present invention, however, it is not mandatory that the mold bottom MB and, in particular, the complete mold bottom MB is heated. Rather, according to some embodiments of the inventive process, the mold bottom MB is not or only locally heated, in particular in areas, in which ink is intended to be applied in a subsequent process step.

As illustrated in FIG. 3B, after heating the mold bottom MB to a desired temperature of approximately 80 degrees Celsius, ink may be applied at a predefined area or at predefined areas to the mold bottom MB. The ink applied to the mold bottom MB serves as material for the first decorative layer 30 in the completed interior component 10.

The ink, i.e., the material of the first decorative layer 30, may be applied to the mold bottom MB by printing. For this purpose, a print pad PP may be utilized as schematically illustrated in FIG. 3B.

According to other embodiments disclosed herein, however, the ink, i.e., the material of the first decorative layer 30, may be applied to the mold bottom MB by other techniques, in particular printing techniques or spraying techniques.

As schematically illustrated in FIG. 3B, the ink (material of the first decorative layer 30) is applied to the mold bottom MB in such an amount that the ink forms a layer having a thickness, e.g. of approximately 40 mm.

Since the ink (the material of the first decorative layer 30) may be applied to a heated mold bottom MB, the ink hardly dries up on the mold bottom MB and doesn't blur. This allows a sharp and unblurred borderline between the material of the base 20 and the material of the first decorative layer 30 in the completed vehicle interior component 10.

After applying ink to the mold bottom MB, the mold top, i.e. the other half mold, is arranged with regard to the mold bottom MB so that a mold cavity is defined.

In more detail, according to the exemplary embodiment schematically illustrated in FIGS. 3A to 3F, the two mold plates MB, MT are movable relative to each other and define a mold cavity. More particularly and as illustrated in FIG. 3C, in a closed state of the mold, inner surfaces of the mold plates MB, MT and/or the material (ink) of the first decorative layer 30 applied to the mold bottom MB cooperate to collectively define the mold cavity when the mold plates MB, MT are abutted generally along matting surfaces.

As schematically illustrated in FIG. 3C, the so-formed mold cavity is a gap area between the mold bottom MB and the mold top MT. As further schematically illustrated in FIG. 3C, an injection-molding tool is provided in order to inject molten resin into the mold cavity thereby forming the base 20.

In more detail and as schematically illustrated in FIG. 3D, resin, preferably, molten resin is injected between the ink, i.e. the material of the first decorative layer 30 and the mold top MT to provide the component 20.

When injecting resin, the material of the base 20 flows around the ink (material of the first decorative layer 30). During curing of the injected resin, a direct mechanical bonding between the ink and the resin occurs, as schematically illustrated in FIG. 3E. Accordingly, the base 20 comprises a depression in its surface adjacent to the mold bottom, wherein the first decorative layer 30 is at least partly contained in this depression.

Finally, the vehicle interior component 10 is demolded after the curing process has been terminated. For this purpose, the mold is opened as illustrated in FIG. 3F.

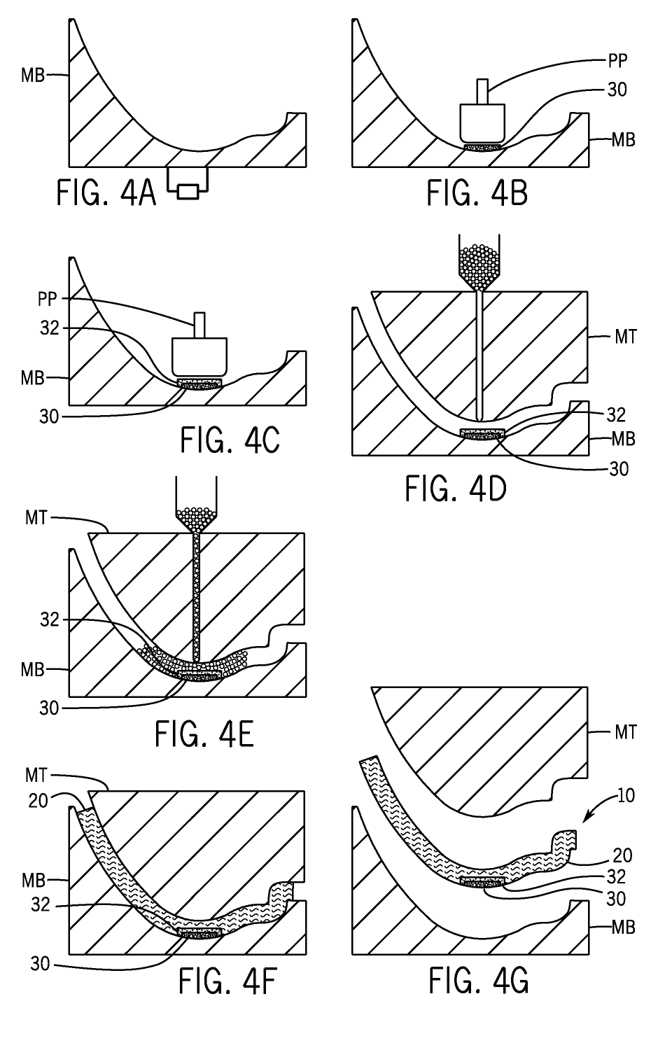

Referring to FIGS. 4A to 4G, a process for making a vehicle interior component 10 according to another exemplary embodiment will be described in more detail.

According to this exemplary embodiment, a mold assembly comprising a mold bottom MB and a molt top MT is provided. As schematically illustrated in FIG. 4A, at least the mold bottom MB is preferably heated at least partially by means of a heating device schematically illustrated in FIG. 4A.

Thereafter, a material (here: ink) for the first decorative layer 30 is applied to predefined areas of the mold bottom MB. The ink, which serves as material of the first decorative layer 30, may be applied by printing or spraying. In the embodiment schematically illustrated in FIG. 4B, the ink, i.e., the material of the first decorative layer 30, is applied to dedicated areas of the mold bottom MB by using a print pad PP.

Thereafter, a second decorative layer 32 may be applied to the mold bottom MB and the already applied material (here: ink) of the first decorative layer 30. The material of the second decorative layer 32 may be applied by printing and/or spraying.

As schematically illustrated in FIG. 4C, in the exemplary embodiment, the material of the second decorative layer 32 is applied to the mold bottom MB and also applied to the material (ink) of the first decorative layer 30 by using a print pad PP. The second decorative layer 32 comprises a first front surface, a second front surface, and a rear surface, wherein the second decorative layer 32 is applied to the mold bottom MB and the already applied material of the first decorative layer 30 such that the second front surface of the second decorative layer 32 is adjacent the rear surface of the first decorative layer 30.

The surface of the mold bottom may be entirely covered by the material of the first decorative layer and the material of the second decorative layer.

According to the exemplary embodiment schematically illustrated in FIG. 4C, however, only parts of the surface of the mold bottom MB are covered by the material of the first decorative layer 30 and the material of the second decorative layer 32.

After applying the material of the second decorative layer 32, the mold is closed by moving the mold top MT relative to the mold bottom MB such that a mold cavity is formed. In a closed state of the mold (see FIG. 4D) inner surfaces of the mold plates MB, MT and/or the rear surface of the second decorative layer 32 cooperate to collectively define the mold cavity when the mold plates MB, MT are abutted generally along matting surfaces.

As schematically illustrated in FIG. 4D, the so-formed molding cavity may be a corresponding gap area.

As illustrated in FIG. 4E, when resin is injected between the material of the first decorative layer 30, the material of the second decorative layer 32 and the mold top, the resin flows around the material of the first decorative layer 30 and the material of the second decorative layer 32 such as to allow that the material of the second decorative layer is at least partly transferred to the resin, thereby forming a direct mechanical bonding between the material of the second decorative layer 32, the material of the first decorative layer 30, and the resin. This direct mechanical bonding occurs during curing of the resin material as illustrated in FIG. 4F.

Finally, the vehicle trim component 10 is demolded after the curing process has been terminated. For this purpose, the mold is opened as illustrated in FIG. 4G.

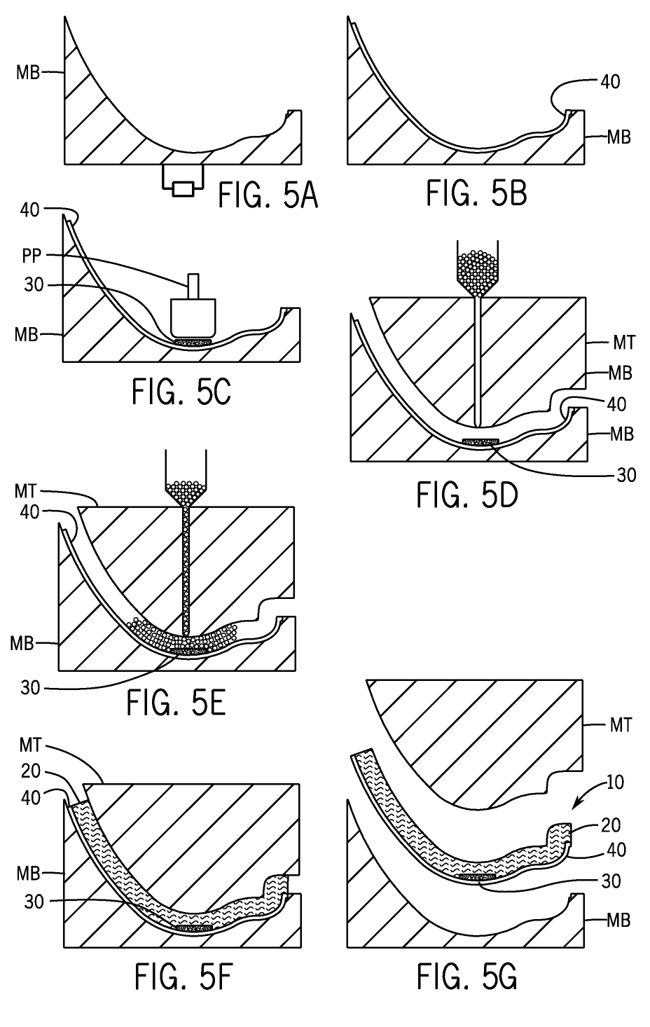

Referring to FIGS. 5A to 5G, a process for manufacturing a vehicle interior trim component 10 according to another exemplary embodiment of the present disclosure will be described in greater detail.

In more detail, the process schematically illustrated in FIGS. 5A to 5G mostly corresponds to the process schematically illustrated in FIGS. 3A to 3F; however, prior to applying ink to the mold bottom MB (e.g. FIG. 5C), a protective layer 40 may be applied to the mold bottom MB as schematically illustrated in FIG. 5B.

In more detail, according to the process schematically illustrated in FIGS. 5A to 5G, the mold bottom MB of the mold is heated. Thereafter, a protective layer may be applied to the complete surface of the mold bottom MB or alternatively to parts of the surface of the mold bottom MB. In the process schematically illustrated in FIG. 5B, the complete “A”-surface of the mold bottom MB is covered by the protective layer 40.

The protective layer 40 may be applied to the mold bottom MB by printing or spraying. Of course, other methods for applying the protective layer 40 are also possible.

After applying the protective layer 40 to the mold bottom MB, the material of the first decorative layer 30 (here: ink) is applied preferably to dedicated areas of a rear surface of the already applied protective layer 40.

As schematically illustrated in FIG. 5C, the material of the first decorative layer 30 may be applied to the rear surface of the protective layer 40 by printing, e.g. by means of a corresponding print pad PP.

Thereafter, the mold is closed by moving a mold top relative to the mold bottom such as to form a mold cavity defined by the inner surfaces of the mold plates MB, MT and/or the rear surface of the protective layer 40 and/or the rear and side surfaces of the material of the first decorative layer 30.

When injecting resin into the so-formed mold cavity (e.g. FIG. 5E), the resin flows around the material of the first decorative layer 30 thereby providing a direct mechanical bonding between the material of the base 20, the material of the protective layer 40 and the material of the first decorative layer 30. In more detail, a direct mechanical bonding takes place when curing the injective resin, as schematically illustrated in FIG. 5F.

After the curing process has been terminated, the vehicle interior component 10 is demolded by removing the component 10 from the mold top MT and/or the mold bottom MB, as schematically illustrated in FIG. 5G.

As indicated in FIG. 5G, the protective layer 40 covers the surface of the base 20 and the first decorative layer 30 of the component 10 thereby protecting the respective surfaces of the base 20 and the first decorative layer 30.

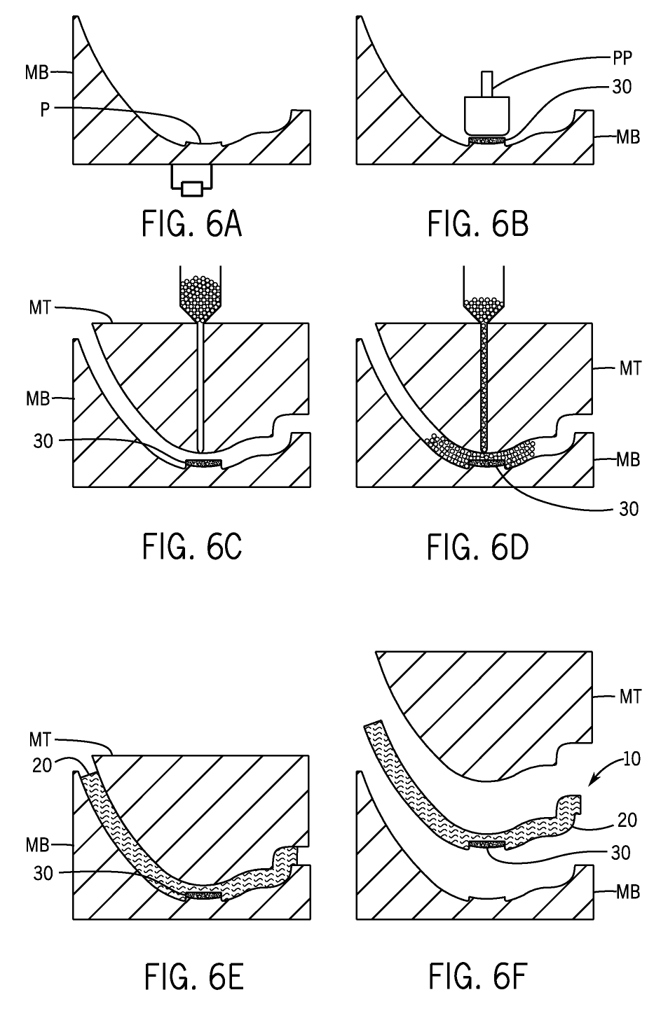

Referring now to FIGS. 6A to 6F, a process for manufacturing a vehicle interior component 10 according to another exemplary embodiment of the present disclosure will be described in greater detail.

In principle, the process schematically illustrated in FIGS. 6A to 6F corresponds to the process schematically illustrated in FIGS. 3A to 3F. Contrary to the process schematically illustrated in FIG. 3A to 3F, however, in the process according to FIGS. 6A to 6F, the mold bottom MB is provided with a protruding area P, which serves for receiving the material of the first decorative layer 30. In this regard, reference is made to FIGS. 6A and 6B.

By providing such a protruding area P in the surface of the mold bottom MB, the first decorative layer 30 is deeper embedded in the base 20 as schematically illustrated in FIG. 6F, thereby providing a further enhanced appearance of the first decorative layer 30 in the completed component 10.

The protruding area P in the surface of the mold bottom MB may have a height of approximately 2 mm, and preferably a height of approximately 1 mm.

In some embodiments disclosed herein, the ink (i.e., the material of the first decorative layer 30) is at least partly absorbed into the material of the base 20 (i.e., injection molded resign) by the process of injection molding.

In more detail, the occurring bonding and adhesion phenomena between the ink 30 and the material of the base 20 (i.e., injection molded resign) may vary depending on various parameters. The formation of bonds between a relatively cold ink material, which was inserted or applied onto the surface of the mold cavity before injection molding, and an injected polymer melt may depend particularly from the temperature of the mold surface and a process timing, i.e., a time-period between applying the ink and injection molding. Providing sufficient bond strength, at least some of the ink material is transferred to the injection molded resin. Possibly influencing factors on the bond strength are a temperature of the mold surface and process timing, i.e., a time-period between applying the ink and injection molding.

For example, in some embodiments disclosed herein, only a very thin (if any) mixing or absorption area may be formed in a region between the ink material of the first decorative layer 30 and the resin material of the base 20. Such a state may be formed by providing a relatively low temperature of the mold (approximately 40 degrees Celsius), while at the same time a relative long process time between applying the ink and resign injection is selected. This process time may be approximately up to 300 seconds.

In other embodiments, however, much more ink material of the first decorative layer 30 may be absorbed into the resin material of the base 20 during resin injection and curing.

For example, a relative broad/thick mixing or absorption area may be formed in a region between the ink material of the first decorative layer 30 and the resin material of the base 20. Such a state may be formed by providing a relatively high temperature of the mold (approximately up to 80 degrees Celsius), while at the same time a relative short process time between applying the ink and resin injection is selected. This process time may be approximately not more than 120 seconds.

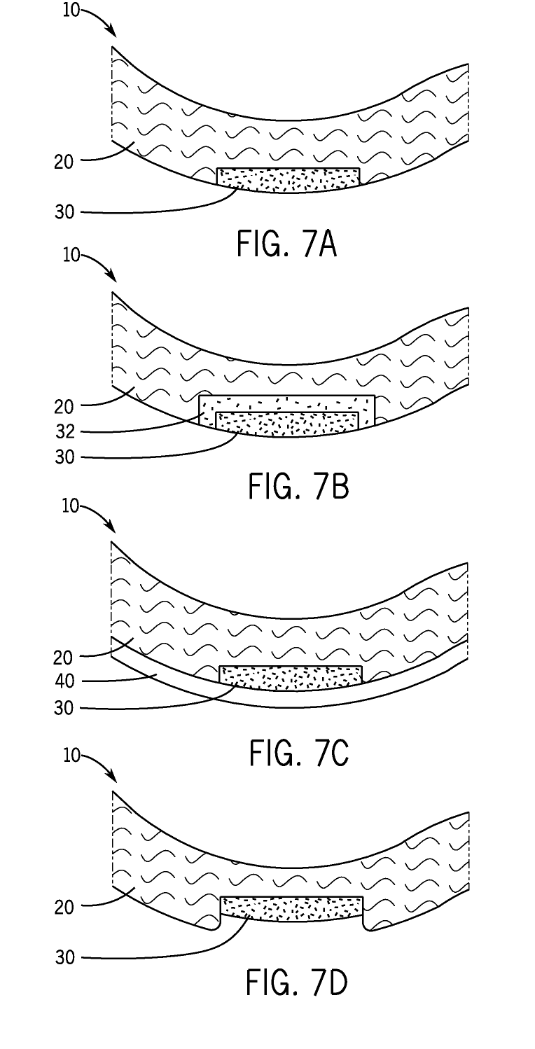

Referring to FIGS. 7A to 7D the component 10 with base 20 (e.g. resin, plastic, injection molded material, etc.) and decorative layer 30 (e.g. ink, deposit, etc.) is shown schematically in partial cross-section according to exemplary embodiments.

In FIG. 7A the layer 30 has been deposited (e.g. by pad printing, ink jet printing, nozzle, spray, etc.) in the mold and heated (e.g. warmed, softened, etc.) before molded material for base 20 is injected behind layer 30 in the mold to form the component 10; the mold is then cooled and the component with layer 30 bonded to base 20 is removed or ejected.

In FIG. 7B the component 10 comprises two decorative layers (30, 32) with a second layer 32 deposited over a first layer 30 in the mold with the material for base 20 injected behind second layer 32 in the mold. Component 10 is provided with visible effect produced by adjacent first layer 30 and second layer 32 in base 20 (e.g. adhered, bonded, etc.).

In FIG. 7C a protective layer 40 is deposited (e.g. by pad printing, ink jet printing, sheet, strip, film, etc.) in the mold; then layer 30 is deposited in the mold (e.g. at least partially onto protective layer 40); the mold is heated (e.g. to soften the layers) before molded material for base 20 is injected behind layer 30 in the mold to form the component 10 with layer 30 bonded to base 20 formed with protection layer 40 (e.g. bonded to the surface).

In FIG. 7D the layer 30 has been deposited (e.g. by pad printing, ink jet printing, etc.) on a feature (e.g. raised or embossed area, ridge, line, etc.) in the mold; the feature forms a depression (e.g. indentation, recess, etc.) in the component 10 and base 20 for the layer 30 when molded material for base 20 is injected to form the component 10.

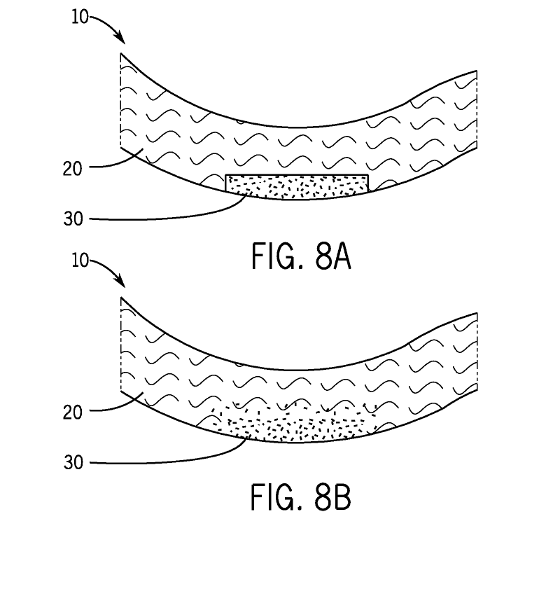

Referring to FIGS. 8A and 8B the effect of operating conditions of the formation of component 10 with base 20 and layer 30 is indicated schematically.

In FIG. 8A the layer 30 has been deposited (e.g. by pad printing, ink jet printing, etc.) in the mold and heated to a sufficient temperature for softening (e.g. melting, bonding etc.); molded material for base 20 is injected behind layer 30 in the mold to form the component 10; at the sufficient temperature the material of layer 30 and the material of layer base 20 bond (e.g. adhere, attach, etc.) in a manner that a relatively distinct transition between layer 30 and base 20 is visible in component 10 (e.g. by indicated schematically in cross section).

In FIG. 8B the layer 30 has been deposited (e.g. by pad printing, ink jet printing, etc.) in the mold and heated to a sufficient temperature for absorption (e.g. fusion, diffusion, etc.) with molded material for base 20 injected behind layer 30 in the mold to form the component 10; at the sufficient temperature the material of layer 30 and the material of layer base 20 combine (e.g. fuse, diffuse, merge, melt, absorb, etc.) in a manner that a less distinct transition between layer 30 and base 20 is visible in component 10 (e.g. indicated schematically by in cross section); as indicated schematically the materials may merge or be absorbed in a partial form or gradient (e.g. depending upon material properties and operating conditions).

According to exemplary embodiments, operating conditions for the system and method would be the same as those used for conventional injection molding of plastics or resins. According to a preferred embodiment operating conditions would be adapted to achieve the intended effect upon layer 30 and base 20 to form component 10. For example, to achieve a bond of layer 30 on base 20 as indicated schematically in FIGS. 7A and 8A, the mold would be heated to approximately 30 to 40 degrees Celsius before injection molding of the base (with the material heated to the melting point for the injection molding process, e.g. from 180 degrees Celsius to 260 degrees Celsius or more as required); before demolding the component the mold would be cooled as in a conventional injection molding process (e.g. cooled to 30 to 40 degrees Celsius); see also FIGS. 7B to 7D.

For example, to achieve absorption of layer 30 with base 20 as indicated schematically in FIG. 8B, the mold would be heated to approximately 80 to 100 degrees Celsius before injection molding of the base (with the material heated to the melting point for the injection molding process, e.g. from 180 degrees Celsius to 260 degrees Celsius or more as required); before demolding the component the mold would be cooled as in a conventional injection molding process (e.g. cooled to 30-40 degrees Celsius).

The steps of heating the mold and depositing (e.g. printing, etc.) the layer may be reversed according to an alternative embodiment.

According to an exemplary embodiment, the base may be formed from polycarbonate, polypropylene, acrylonitrile butadiene styrene, engineered plastics/resins, etc.; and the layer may be formed from printing inks made of resin matrix, solvent and pigments, wherein the matrix is formed from acrylic resin, polyurethane resin, polyester resin or mixtures, etc.

According to another exemplary embodiment not illustrated in the drawings, the mold bottom MB may not be provided with a protruding area P, but with a recess for accommodating at least partly the material of the first decorative layer. Such a recess may further increase the sharpness of the first decorative layer 30 in the component 10, because any blurring of the material of the first decorative layer during injection of resin may be effectively avoided.

According to an embodiment of the inventive process for manufacturing a trim component 10, a coating in the form of a printed image is applied to a mold surface. For this purpose a pad printing unit may be used for transferring an ink pattern to a surface of the forming tool.

Subsequently, at least the support structure of the interior trim component 10 is injection molded by injecting plastic in the forming tool, which is preferably an injection forming tool. The viscous melt flows around the color patterns previously applied to the surface of the forming tool. By the inflowing molten plastic material a high adhesion between the color pattern and the material of the plastic melt is produced.

Subsequently the interior trim component 10 is unmolded. The color pattern is then completely embedded in the plastic material.

In accordance with some embodiments, the support structure (base) of the interior component 10, which has been molded by injection molding, may have a recessed portion, which may serve for forming a backlight. A light source, in particular an LED light source, may be accommodated in the recessed portion in such a manner that light is emitted in the direction of the transferred ink pattern. In this way, a background illuminable area is integrated into the interior component 10 in an easy to implement and efficient manner and without the need for additional processing steps.

In accordance with a further embodiment of the process according to the invention, a color pattern of a coating is introduced in the material of the support structure (base) by means of a plunger serving as molding aid. For this purpose, a color pattern was initially transferred onto the surface of the plunger, preferably by means of a pad printing unit.

Then, the plunger together with the color pattern applied on the surface of the plunger may be driven into a thermoplastic melt. In this way, a material bond between the plastic material and the color pattern may be formed.

After cooling the thermoplastic melt, the interior component 10 together with the embedded color pattern may be removed from the mold.

Although not shown in the drawings, it is of course conceivable that—prior to contact with the thermoplastic melt—an adhesion promoter, etc. is transferred to the applied color pattern in order to increase the adhesion between the color pattern and the plastic molded part.

Moreover, it has proved to be advantageous when the color pattern is transferred to the surface 21 of a heated mold, so that during injection of the thermoplastic melt in the subsequent process step, the color pattern is already partially dried and the contours of the printed image contain less solvent than the interior of the ink layer. In this way, a particularly good adhesion between the injected plastic material and the color may be provided.

Studies have shown that in particular a mold temperature in a range between 60 to 120 degrees Celsius, preferably between 80 to 110 degrees Celsius, and most preferably about 100 degrees Celsius give particularly good ink transfer results, which ensures a particularly accurate reproduction of details.

The invention is not limited to the embodiments schematically illustrated in the drawings, but results from a synopsis of all the features disclosed herein.

In particular, the invention is not so limited that only the A-side of the finished interior trim part is refined and, in particular, decorated by applying at least one coating to the surface of the forming tool, and by subsequently introducing a thermoplastic substrate, which is heated at or above its softening temperature, into the forming tool.

In particular, it is conceivable that—in addition or alternatively to the integration of a print image in the A-side of the interior trim part—a print image is integrated into the B-side of the interior trim part. This may be done by providing a base body consisting of a thermoplastic carrier material, which is heated at or above the softening temperature of the thermoplastic material, and then by shaping the heated base body in the forming tool, in particular by driving a plunger into the forming tool, wherein at least one coating has been applied on the surface of the plunger prior to driving the plunger into the forming tool.

The inventive process enables a wide range of products to be produced. In practicing the invention in order to obtain a class A surface on the product, the bottom mold and/or top mold may be polished.

What is claimed as new and desired to be protected is set forth in the appended claims and includes equivalents of the elements recited therein.

It is important to note that the construction and arrangement of the elements of the inventive concepts and inventions as described in this application and as shown in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. Accordingly, all such modifications are intended to be included within the scope of the present inventions. Other substitutions, modifications, changes and omissions may be made in the design, operating conditions and arrangement of the preferred and other exemplary embodiments without departing from the spirit of the present inventions.

It is important to note that the apparatus of the present inventions may comprise conventional technology (e.g. as implemented in present configuration) or any other applicable technology (present or future) that has the capability to perform the functions and processes/operations indicated in the FIGURES. All such technology is considered to be within the scope of the present inventions and application.

1. A component for a vehicle interior comprising:
(a) a base comprising a surface and a depression in the surface; and
(b) a first decorative layer coupled to the base and comprising a front surface and a rear surface;
wherein the first decorative layer is at least partially contained in the depression of the surface of the base; and
wherein the first decorative layer is at least partially absorbed into the base.

2. The component of claim 1 wherein the first decorative layer is at least partially absorbed into the base as the base and the first decorative layer are molded into a shape.

3. The component of claim 1 further comprising a protective layer wherein the protective layer is configured to cover the surface of the base and the first decorative layer.

4. The component of claim 1 wherein the first decorative layer is fully contained in the depression of the base.

5. The component of claim 1 wherein the front surface of the first decorative layer is substantially adjacent to the surface of the base.

6. The component of claim 1 wherein a depth of the depression is substantially greater than a thickness of the first decorative layer.

7. The component of claim 1 further comprising a second decorative layer comprising a first front surface, a second front surface and a rear surface wherein the second front surface of the second decorative layer is adjacent the rear surface of the first decorative layer.

8. The component of claim 7 wherein the first front surface of the second decorative layer is substantially adjacent to the front surface of the first decorative layer.

9. The component of claim 8 wherein the first front surface of the second decorative layer is substantially adjacent to the surface of the base.

10. The component of claim 1 wherein the first decorative layer comprises ink.

11. A method of manufacturing a vehicle component for a vehicle interior comprising the steps of:
(a) providing a mold comprising a mold bottom and a mold top;
(b) heating the mold bottom;
(c) providing a decorative layer in the mold;
(d) closing the mold;
(e) injecting resin (a) between the decorative layer and the mold top and (b) between the mold bottom and the mold top to form a base and to provide the vehicle component; and
(f) removing the vehicle component from the mold.

12. The method of claim 11 further comprising the step of partially absorbing at least a portion of the decorative layer into the base.

13. The method of claim 11 further comprising the step of applying a protective layer to the mold bottom.

14. The method of claim 13 wherein providing the decorative layer in the mold comprises applying the decorative layer to the protective layer.

15. The method of claim 11 wherein the decorative layer comprises ink.

16. A vehicle trim component prepared by a process comprising:
(a) providing a mold comprising a mold bottom and a mold top;
(b) heating the mold bottom;
(c) providing a decorative layer in the mold;
(d) closing the mold;
(e) injecting resin (a) between the decorative layer and the mold top and (b) between the mold bottom and the mold top to form a base and to provide the component; and removing the component from the mold.

17. The vehicle trim component of claim 16 wherein the process comprises the step of partially absorbing at least a portion of the decorative layer into the base.

18. The vehicle trim component of claim 16 wherein the process comprises the step of applying a protective layer to the mold bottom.

19. The vehicle trim component of claim 18 wherein providing the decorative layer in the mold comprises applying the decorative layer to the protective layer.

20. The vehicle trim component of claim 16 wherein the decorative layer comprises ink.
